(19) United States
(12) Patent Application Publication
(10) Pub. No.: US 2026/0101031 A1
(43) Pub. Date: Apr. 9, 2026

(54) Method and Apparatus of Matrix Weighted Intra Prediction in Video Coding System

(71) Applicant: MEDIATEK INC., Hsinchu City (TW)

(72) Inventors: Man-Shu CHIANG, Hsinchu City (TW); Chih-Wei HSU, Hsinchu City (TW)

(21) Appl. No.: 19/120,871

(22) PCT Filed: Oct. 20, 2023
(86) PCT No.: PCT/CN2023/125730

§ 371 Date: Apr. 14, 2025

Related U.S. Application Data
(60) Provisional application No. 63/380,396, filed on Oct. 21, 2022.

(51) Int. Cl. H04N 19/11; H04N 19/176

(52) U.S. Cl. CPC H04N 19/11; H04N 19/176

(57) ABSTRACT

A method and apparatus for matrix weighted intra prediction. According to this method, input data associated with a current block are received, wherein the input data comprise pixel data to be encoded at an encoder side or coded data associated with the current block to be decoded at a decoder side, and wherein a target prediction mode is determined from a candidate mode group for the current block and the candidate mode group comprises a Matrix-based Intra Prediction (MIP) mode. A traditional intra prediction mode is determined from a traditional intra mode group, wherein the traditional intra mode group comprises multiple angular intra prediction modes, wherein the traditional intra prediction mode is used to process the current block, a subsequent block, and/or a collocated block of the current block. The current block is encoded or decoded using the target prediction mode.

### CROSS REFERENCE TO RELATED APPLICATIONS

The present invention is a non-Provisional Application of and claims priority to U.S. Provisional Patent Application No. 63/380,396, filed on Oct. 21, 2022. The U.S. Provisional Patent Application is hereby incorporated by reference in its entirety.

### FIELD OF THE INVENTION

The present invention relates to video coding system. In particular, the present invention relates to schemes to improve performance of intra prediction coding using matrix weighted intra prediction mode.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously encoded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In the present invention, methods to improve the performance of matrix weighted intra prediction mode are disclosed.

### BRIEF SUMMARY OF THE INVENTION

A method and apparatus for video coding are disclosed. According to this method, input data associated with a current block are received, wherein the input data comprise pixel data to be encoded at an encoder side or data associated with the current block to be decoded at a decoder side, wherein a target prediction mode is determined from a candidate mode group for the current block and the candidate mode group comprises a Matrix-based Intra Prediction (MIP) mode. A traditional intra prediction mode is determined from a traditional intra mode group, wherein the traditional intra mode group comprises multiple angular intra prediction modes, wherein the traditional intra prediction mode is used to process the current block, a subsequent block, and/or a collocated block of the current block. The current block is encoded or decoded using the target prediction mode.

In one embodiment, the traditional intra prediction mode is used for the current block during transform or inverse transform stage. In one example, traditional intra prediction mode is used for the current block to select a transform set and/or a transpose flag and/or a transform kernel for secondary transform. In another example, the traditional intra prediction mode is used for the current block to select a transform set and/or transform kernel and/or a transpose flag for primary transform.

In one embodiment, the traditional intra prediction mode is used by a subsequent coding block to construct a Most Probably Mode (MPM) list.

In one embodiment, the current block corresponds to a luma block and the traditional intra prediction mode is used by a collocated chroma block to decide a chroma derived mode (DM).

In one embodiment, the traditional intra prediction mode corresponds to a pre-defined intra prediction mode. In one embodiment, the pre-defined intra prediction mode is derived according to histogram/gradient/distortion analysis on template of the current block and/or histogram/gradient/distortion analysis on the current block. In another embodiment, the pre-defined intra prediction mode corresponds to DC, planar, horizontal, vertical, diagonal, or any pre-defined mode from available intra prediction modes. Furthermore, the pre-defined intra prediction mode is selected to be the DC, planar, horizontal, vertical, diagonal, or any pre-defined mode from available intra prediction modes according to one or more implicit rules. In one embodiment, the pre-defined intra prediction mode is the pre-defined intra prediction mode is determined according to block size of the current block. In one embodiment, the pre-defined intra prediction mode is determined according a syntax in a block, tile, slice, picture, SPS (Sequence Parameter Set), or PPS (Picture Parameter Set) level.

In one embodiment, the traditional intra prediction mode is stored in a buffer for intra prediction modes. Furthermore, the traditional intra prediction mode stored in the buffer is accessed by the current block, the subsequent block, and/or the collocated block.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 3 illustrates an example of the signalling mechanism of the partition splitting information in quadtree with nested multi-type tree coding tree structure.

FIG. 4 shows an example of a CTU divided into multiple CUs with a quadtree and nested multi-type tree coding block structure, where the bold block edges represent quadtree partitioning and the remaining edges represent multi-type tree partitioning.

FIG. 5 shows some examples of TT split forbidden when either width or height of a luma coding block is larger than 64.

FIG. 6 shows the intra prediction modes as adopted by the VVC video coding standard.

FIG. 7 illustrates the locations of the neighbouring blocks (L, A, BL, AR, AL) used in the derivation of a general MPM list.

FIGS. 8A-B illustrate examples of wide-angle intra prediction a block with width larger than height (FIG. 8A) and a block with height larger than width (FIG. 8B).

FIG. 9A illustrates an example of selected template for a current block, where the template comprises T lines above the current block and T columns to the left of the current block.

FIG. 9B illustrates an example for T=3 and the HoGs (Histogram of Gradient) are calculated for pixels in the middle line and pixels in the middle column.

FIG. 9C illustrates an example of the amplitudes (ampl) for the angular intra prediction modes.

FIG. 10 illustrates an example of the blending process, where two angular intra modes (M1 and M2) are selected according to the indices with two tallest bars of histogram bars.

FIGS. 11A-C illustrate an example of the DIMD chroma mode using the DIMD derivation method to derive the chroma intra prediction mode of the current block based on the neighbouring reconstructed Y (FIG. 11A), Cb (FIG. 11B) and Cr (FIG. 11C) samples in the second neighbouring row and column.

FIG. 12 illustrates an example of template-based intra mode derivation (TIMD) mode, where TIMD implicitly derives the intra prediction mode of a CU using a neighbouring template at both the encoder and decoder.

FIG. 13A illustrates an example of Intra Sub-Partition (ISP), where a block is partitioned into two subblocks horizontally or vertically.

FIG. 13B illustrates an example of Intra Sub-Partition (ISP), where a block is partitioned into four subblocks horizontally or vertically.

FIG. 14 illustrates an example of processing flow for Matrix weighted intra prediction (MIP).

FIG. 15 illustrates an example of the of 64 partitions used in the VVC standard, where the partitions are grouped according to their angles and dashed lines indicate redundant partitions.

FIG. 16 illustrates an example of uni-prediction MV selection for the geometric partitioning mode.

FIG. 17 illustrates an example of blending weight @, using the geometric partitioning mode.

FIG. 18 illustrates an example of the weight value derivation for Combined Inter and Intra Prediction (CIIP) according to the coding modes of the top and left neighbouring blocks.

FIGS. 19A-C illustrate examples of available IPM candidates: the parallel angular mode against the GPM block boundary (Parallel mode, FIG. 19A), the perpendicular angular mode against the GPM block boundary (Perpendicular mode, FIG. 19B), and the Planar mode (FIG. 19C), respectively.

FIG. 19D illustrates an example of GPM with intra and intra prediction, where intra prediction is restricted to reduce the signalling overhead for IPMs and hardware decoder cost.

FIG. 20A illustrates the syntax coding for Spatial GPM (SGPM) before using a simplified method.

FIG. 20B illustrates an example of simplified syntax coding for Spatial GPM (SGPM).

FIG. 21 illustrates an example of template for Spatial GPM (SGPM).

FIGS. 22A-B illustrate the scan orders of the LFNST output with different LFNST transpose flag, where FIG. 22A is for flag equal to 0 and FIG. 22B is for flag equal to 1.

FIG. 23 illustrates an example of processing flow for Matrix weighted intra prediction (MIP).

FIG. 24 illustrates an example of LFNST modification for MIP coded blocks, which utilizes DIMD to derive the LFNST transform set and determine LFNST transpose flag.

FIG. 25 illustrates a flowchart of an exemplary video coding system that incorporates matrix weighted intra prediction mode according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### Partitioning of the CTUs Using a Tree Structure

In HEVC, a CTU is split into CUs by using a quaternary-tree (QT) structure denoted as coding tree to adapt to various local characteristics. The decision whether to code a picture area using inter-picture (temporal) or intra-picture (spatial) prediction is made at the leaf CU level. Each leaf CU can be further split into one, two or four Pus according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

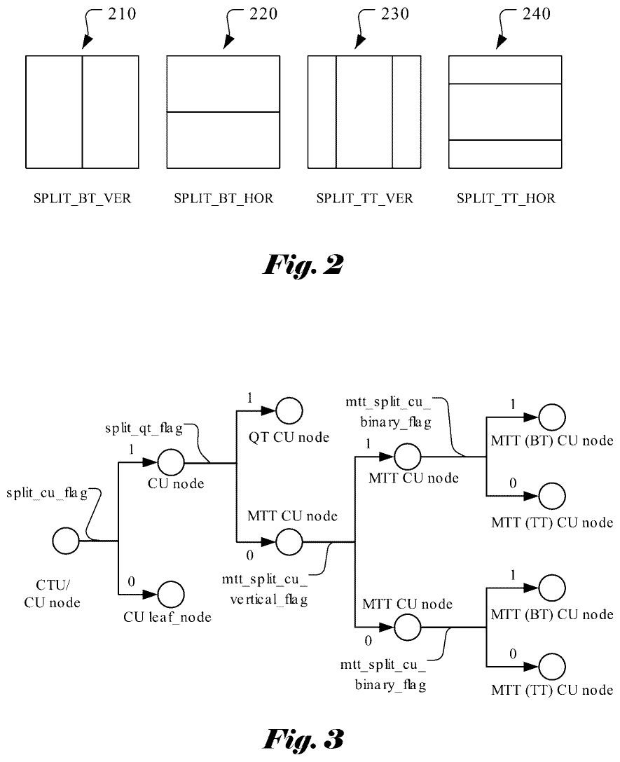

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

FIG. 3 illustrates the signalling mechanism of the partition splitting information in quadtree with nested multi-type tree coding tree structure. A coding tree unit (CTU) is treated as the root of a quaternary tree and is first partitioned by a quaternary tree structure. Each quaternary tree leaf node (when sufficiently large to allow it) is then further partitioned by a multi-type tree structure. In quadtree with nested multi-type tree coding tree structure, for each CU node, a first flag (split_cu_flag) is signalled to indicate whether the node is further partitioned. If the current CU node is a quadtree CU node, a second flag (split_qt_flag) whether it's a QT partitioning or MTT partitioning mode. When a node is partitioned with MTT partitioning mode, a third flag (mtt_split_cu_vertical_flag) is signalled to indicate the splitting direction, and then a fourth flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as shown in Table 1.

TABLE 1
MttSplitMode derviation based on multi-type tree syntax elements

| MttSplitMode | mtt_split_cu_vertical_flag | mtt_split_cu_binary_flag |
|---|---|---|
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

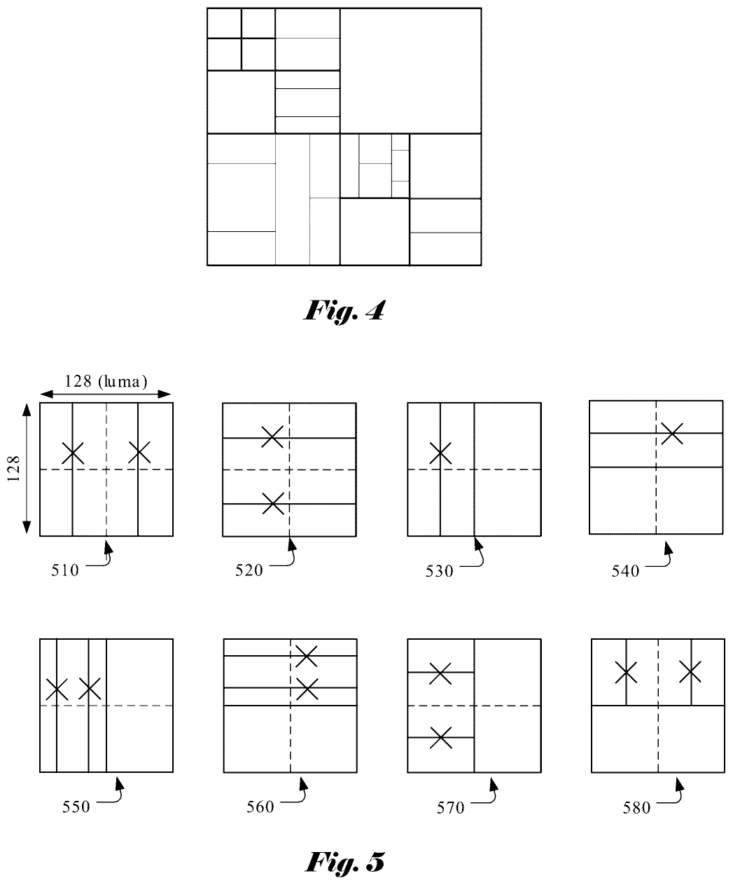

FIG. 4 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined for the quadtree with nested multi-type tree coding tree scheme. These parameters are specified by SPS syntax elements and can be further refined by picture header syntax elements.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMTtDepth: the maximum allowed hierarchy depth of multi-type tree splitting from a quadtree leaf
MinCbSize: the minimum allowed coding block node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinC′bsize (for both width and height) is set as 4×4, and the MaxMTtDepth is set as 4. The quaternary tree partitioning is applied to the CTU first to generate quaternary tree leaf nodes. The quaternary tree leaf nodes may have a size from 16×16 (i.e., the MinQ) TSize) to 128×128 (i.e., the CTU size). If the leaf QT node is 128×128, it will not be further split by the binary tree since the size exceeds the MaxBtSize and MaxTtSize (i.e., 128×128). Otherwise, the leaf qdtree node could be further partitioned by the multi-type tree. Therefore, the quaternary tree leaf node is also the root node for the multi-type tree and it has multi-type tree depth (mttDepth) as 0. When the multi-type tree depth reaches MaxMTtDepth (i.e., 4), no further splitting is considered. When the multi-type tree node has width equal to MinCbsize, no further horizontal splitting is considered. Similarly, when the multi-type tree node has height equal to MinCbsize, no further vertical splitting is considered.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

### Virtual Pipeline Data Units (VPDUs)

Virtual pipeline data units (VPDUs) are defined as non-overlapping units in a picture. In hardware decoders, successive VPDUs are processed by multiple pipeline stages at the same time. The VPDU size is roughly proportional to the buffer size in most pipeline stages, so it is important to keep the VPDU size small. In most hardware decoders, the VPDU size can be set to maximum transform block (TB) size. However, in VVC, ternary tree (TT) and binary tree (BT) partition may lead to the increasing of VPDUs size.

In order to keep the VPDU size as 64×64 luma samples, the following normative partition restrictions (with syntax signalling modification) are applied in VTM, as shown in FIG. 5:
TT split is not allowed (as indicated by “X” in FIG. 5) for a CU with either width or height, or both width and height equal to 128.
For a 128×N CU with N≤64 (i.e. width equal to 128 and height smaller than 128), horizontal BT is not allowed.
For an N×128 CU with N≤64 (i.e. height equal to 128 and width smaller than 128), vertical BT is not allowed.

In FIG. 5, the luma block size is 128×128. The dashed lines indicate block size 64×64. According to the constraints mentioned above, examples of the partitions not allowed are indicated by “X” as shown in various examples (510-580) in FIG. 5.

Intra Mode Coding with 67 Intra Prediction Modes

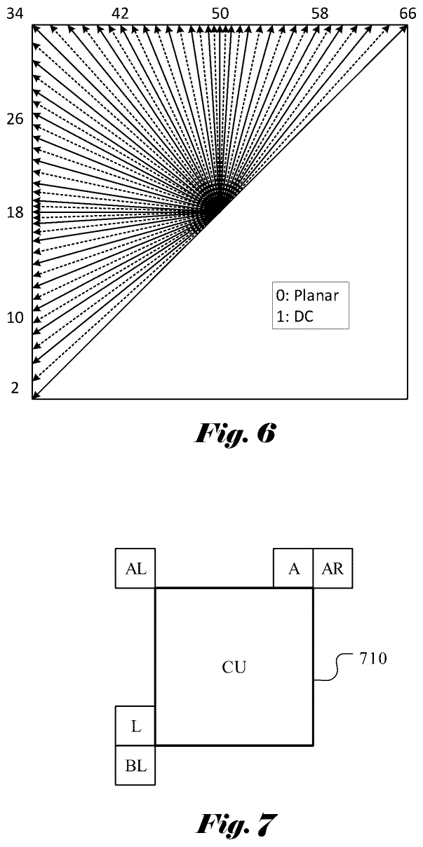

To capture the arbitrary edge directions presented in natural video, the number of directional intra modes in VVC is extended from 33, as used in HEVC, to 65. The new directional modes not in HEVC are depicted as dotted arrows in FIG. 6, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

To keep the complexity of the most probable mode (MPM) list generation low, an intra mode coding method with 6 MPMs is used by considering two available neighbouring intra modes. The following three aspects are considered to construct the MPM list:
Default intra modes
Neighbouring intra modes
Derived intra modes.

A unified 6-MPM list is used for intra blocks irrespective of whether MRL and ISP coding tools are applied or not. The MPM list is constructed based on intra modes of the left and above neighbouring block. Suppose the mode of the left is denoted as Left and the mode of the above block is denoted as Above, the unified MPM list is constructed as follows:
When a neighbouring block is not available, its intra mode is set to Planar by default.
If both modes Left and Above are non-angular modes:

$$MPM list \to \{ Planar , DC , V , H , V - 4 , V + 4 \}$$

If one of modes Left and Above is angular mode, and the other is non-angular:
   Set a mode Max as the larger mode in Left and Above

$$MPM list \to \{ Planar , Max , Max - 1 , Max + 1 , Max - 2 , M + 2 \}$$

If Left and Above are both angular and they are different:
   Set a mode Max as the larger mode in Left and Above
   If Max-Min is equal to 1:

$$MPM list \to \{ Planar , Left , Above , Min - 1 , Max + 1 , Min - 2 \}$$

Otherwise, if Max-Min is greater than or equal to 62:

$$MPM list \to \{ Planar , Left , Above , Min + 1 , Max - 1 , Min + 2 \}$$

Otherwise, if Max-Min is equal to 2:

$$MPM list \to \{ Planar , Left , Above , Min + 1 , Min - 1 , Max + 1 \}$$

Otherwise:

$$MPM list \to \{ Planar , Left , Above , Min - 1 , - Min + 1 , Max - 1 \}$$

If Left and Above are both angular and they are the same:

$$MPM list \to \{ Planar , Left , Left - 1 , Left + 1 , Left - 2 , Left + 2 \}$$

Besides, the first bin of the MPM index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

Secondary MPM lists is introduced as described in JVET-D0114 (Seregin, et al., “Block shape dependent intra mode coding”, Joint Video Exploration Team (JVET) of ITU-T SG 16 WP 3 and ISO/IEC JTC 1/SC 29/WG 11, 4th Meeting: Chengdu, CN, 15-21 Oct. 2016, Document JVET-D0114). The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in the following, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL. FIG. 7 illustrates the locations of the neighbouring blocks (L, A, BL, AR, AL) used in the derivation of a general MPM list for a current block 710.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

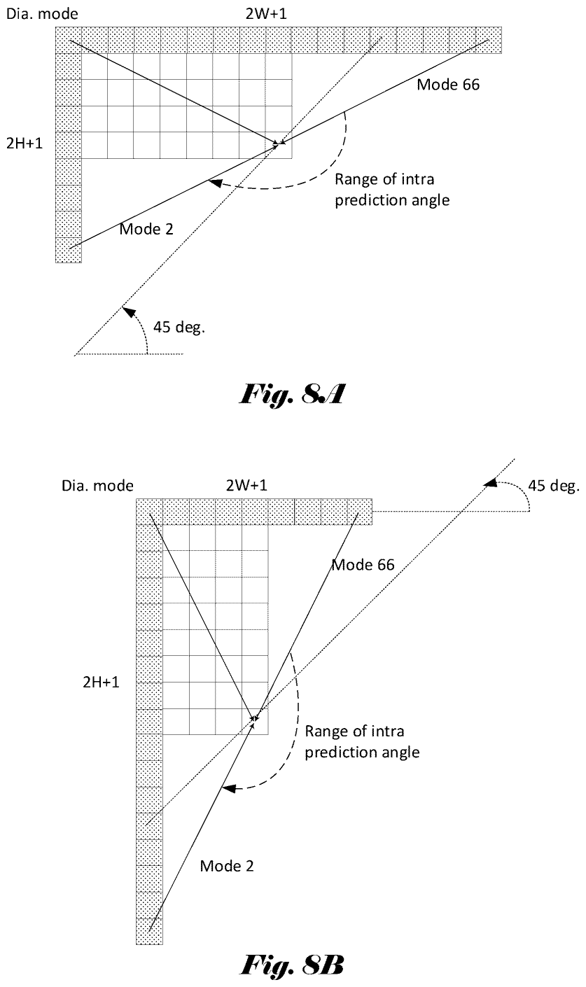

To support these prediction directions, the top reference with length 2W+1, and the left reference with length 2H+1, are defined as shown in FIG. 8A and FIG. 8B respectively.

The number of replaced modes in wide-angular direction mode depends on the aspect ratio of a block. The replaced intra prediction modes are illustrated in Table 2.

TABLE 2
Intra prediction modes replaced by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, 8, 9, 10, 11 |
| W/H == 2 | Modes 2, 3, 4, 5, 6, 7, |
| W/H == 1 | None |
| W/H == 1/2 | Modes 61, 62, 63, 64, 65, 66 |
| W/H == 1/4 | Mode 57, 58, 59, 60, 61, 62, 63, 64, 65, 66 |
| W/H == 1/8 | Modes 55, 56 |
| W/H == 1/16 | Modes 53, 54, 55, 56 |

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135° and above 45°, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### Decoder Side Intra Mode Derivation (DIMD)

When DIMD is applied, two intra modes are derived from the reconstructed neighbour samples, and those two predictors are combined with the planar mode predictor with the weights derived from the gradients. The DIMD mode is used as an alternative prediction mode and is always checked in the high-complexity RDO mode.

To implicitly derive the intra prediction modes of a blocks, a texture gradient analysis is performed at both the encoder and decoder sides. This process starts with an empty Histogram of Gradient (HoG) with 65 entries, corresponding to the 65 angular modes. Amplitudes of these entries are determined during the texture gradient analysis.

In the first step, DIMD picks a template of T=3 columns and lines from respectively left side and above side of the current block. This area is used as the reference for the gradient based intra prediction modes derivation.

In the second step, the horizontal and vertical Sobel filters are applied on all 3×3 window positions, centred on the pixels of the middle line of the template. At each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) , \qquad ( 1 )$$

which can be converted into one of 65 angular intra prediction modes. Once the intra prediction mode index of current window is derived as idx, the amplitude of its entry in the HoG[idx] is updated by addition of:

$$ampl = \vert {G}_{x} \vert + \vert {G}_{y} \vert \qquad ( 2 )$$

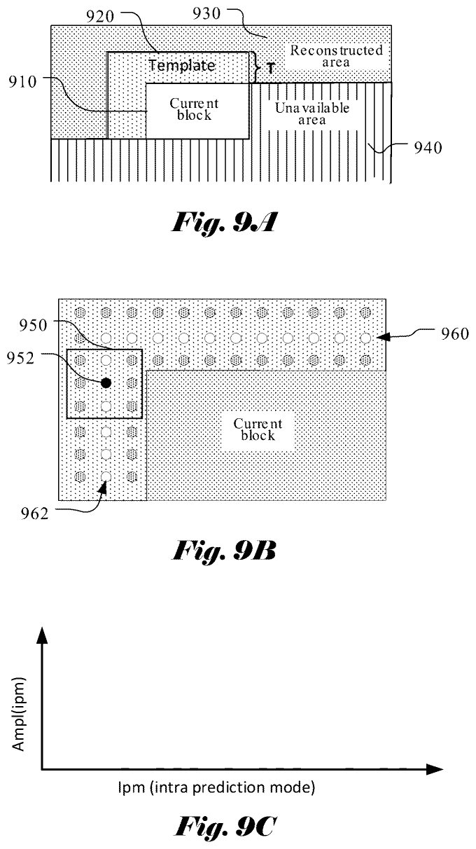

FIGS. 9A-C show an example of HoG, calculated after applying the above operations on all pixel positions in the template. FIG. 9A illustrates an example of selected template 920 for a current block 910. Template 920 comprises T lines above the current block and T columns to the left of the current block. For intra prediction of the current block, the area 930 at the above and left of the current block corresponds to a reconstructed area and the area 940 below and at the right of the block corresponds to an unavailable area. FIG. 9B illustrates an example for T=3 and the HoGs are calculated for pixels 960 in the middle line and pixels 962 in the middle column. For example, for pixel 952, a 3×3 window 950 is used. FIG. 9C illustrates an example of the amplitudes (ampl) calculated based on equation (2) for the angular intra prediction modes as determined from equation (1).

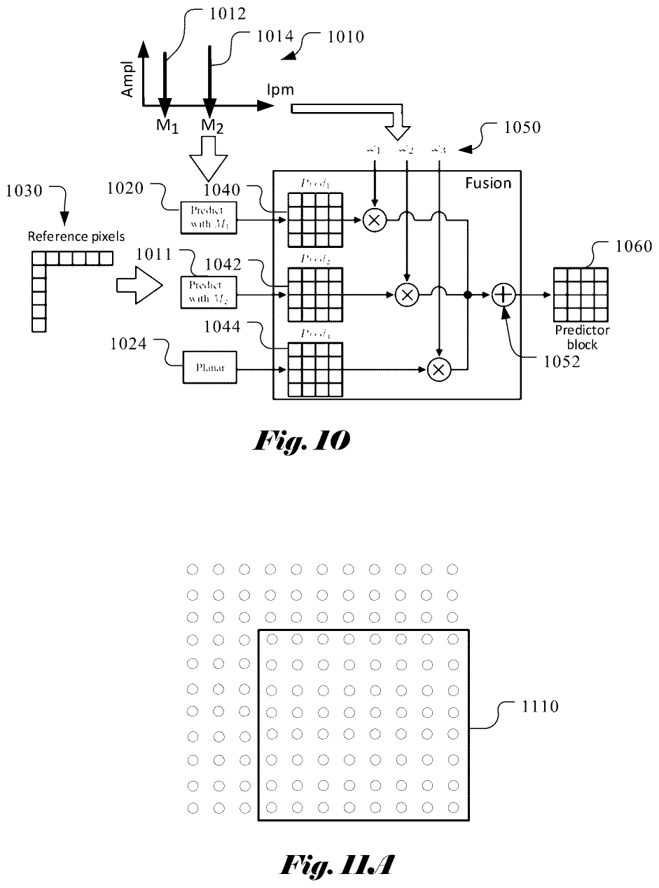

Once HoG is computed, the indices with two tallest histogram bars are selected as the two implicitly derived intra prediction modes for the block and are further combined with the Planar mode as the prediction of DIMD mode. The prediction fusion is applied as a weighted average of the above three predictors. To this aim, the weight of planar is fixed to 21/64 (˜⅓). The remaining weight of 43/64 (˜⅔) is then shared between the two HoG IPMs, proportionally to the amplitude of their HoG bars. FIG. 10 illustrates an example of the blending process. As shown in FIG. 10, two intra modes (M1 1012 and M2 1014) are selected according to the indices with two tallest bars of histogram bars 1010. The three predictors (1040, 1042 and 1044) are used to form the blended prediction. The three predictors correspond to applying the M1, M2 and planar intra modes (1020, 1022 and 1024 respectively) to the reference pixels 1030 to form the respective predictors. The three predictors are weighted by respective weighting factors (ω1, ω2 and ω3) 1050. The weighted predictors are summed using adder 1052 to generated the blended predictor 1060.

Besides, the two implicitly derived intra modes are included into the MPM list so that the DIMD process is performed before the MPM list is constructed. The primary derived intra mode of a DIMD block is stored with a block and is used for MPM list construction of the neighbouring blocks.

When DIMD is applied, two intra modes are derived from the reconstructed neighbour samples, and those two predictors are combined with the planar mode predictor according to the weights derived from the gradients as described in JVET-00449 (Mohsen Abdoli, et al., “Non-CE3: Decoder-side Intra Mode Derivation with Prediction Fusion Using Planar”, Joint Video Exploration Team (JVET) of ITU-T SG 16 WP 3 and ISO/IEC JTC 1/SC 29/WG 11, 15th Meeting: Gothenburg, SE, 3-12 Jul. 2019, Document JVET-00449). The division operations in weight derivation are performed utilizing the same lookup table (LUT)-based integerization scheme used by the CCLM. For example, the division operation (i.e., G_{y}/Gₓ) in the orientation calculation as shown in equation (1) is computed by the following LUT-based scheme:

$$x = Floor ( Log 2 ( G x ) )$$

$$normDiff = ( ( Gx << 4 ) >> x ) \% 15$$

$$x += ( 3 + normDiff != 0 ) ? 1 : 0 )$$

$$Orient = ( Gy ⋆ ( DivSigTable [ normDiff ] \vert 8 ) + ( 1 << ( x - 1 ) ) ) >> x$$

$$where DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes are included in the primary list of intra most probable modes (MPM), so the DIMD process is performed before the MPM list is constructed. The primary derived intra mode of a DIMD block is stored with a block and is used for MPM list construction of the neighbouring blocks.

### DIMD Chroma Mode

The DIMD chroma mode uses the DIMD derivation method to derive the chroma intra prediction mode of the current block based on the neighbouring reconstructed Y, Cb and Cr samples in the second neighbouring row and column as shown in FIGS. 11A-C for Y, Cb and Cr components (FIG. 11A, FIG. 11B and FIG. 11C) respectively. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

When the intra prediction mode derived from the DIMD chroma mode is the same as the intra prediction mode derived from the DM mode, the intra prediction mode with the second largest histogram amplitude value is used as the DIMD chroma mode. A CU level flag is signalled to indicate whether the proposed DIMD chroma mode is applied.

### Fusion of Chroma Intra Prediction Modes

The DM mode and the four default modes can be fused with the MMLM_LT mode as follows:

$$pred = ( w 0 * p r e d 0 + w 1 * p r e d 1 + ( 1 ≪ ( shift - 1 ) ) ) ≫ shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}.

For the syntax design, if a non-LM mode is selected, one flag is signalled to indicate whether the fusion is applied. This method only applies to I slices.

### Template-Based Intra Mode Derivation (TIMD)

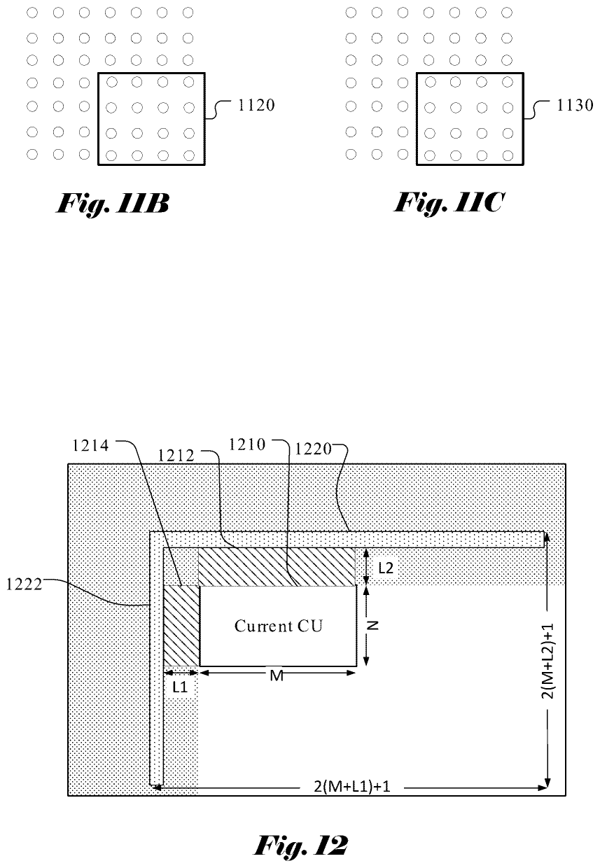

Template-based intra mode derivation (TIMD) mode implicitly derives the intra prediction mode of a CU using a neighbouring template at both the encoder and decoder, instead of signalling the intra prediction mode to the decoder. As shown in FIG. 12, the prediction samples of the template (1212 and 1214) for the current block 1210 are generated using the reference samples (1220 and 1222) of the template for each candidate mode. A cost is calculated as the SATD (Sum of Absolute Transformed Differences) between the prediction samples and the reconstruction samples of the template. The intra prediction mode with the minimum cost is selected as the DIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

For each intra prediction mode in MPMs, the SATD between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test, the cost factor of 2 is applied as follows:

$$costMode 2 < 2 ⋆ costMode 1.$$

If this condition is true, the fusion is applied, otherwise only model is used. Weights of the modes are computed from their SATD costs as follows:

$$weight 1 = costMode 2 / ( costMode 1 + costMode 2 )$$

$$weight 2 = 1 - weight 1.$$

### Intra Sub-Partitions (ISP)

The intra sub-partitions (ISP) divides luma intra-predicted blocks vertically or horizontally into 2 or 4 sub-partitions depending on the block size. For example, the minimum block size for ISP is 4×8 (or 8×4). If block size is greater than 4×8 (or 8×4), then the corresponding block is divided by 4 sub-partitions. It has been noted that the M×128 (with M≤64) and 128×N (with N≤64) ISP blocks could generate a potential issue with the 64×64 VDPU (Virtual Decoder Pipeline Unit). For example, an M×128 CU in the single tree case has an M×128 luma TB and two corresponding M/2×64 chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32× 32 block. Analogously, a similar situation could be created with a 128×N CU using ISP. Hence, these two cases are an issue for the 64×64 decoder pipeline. For this reason, the CU size that can use ISP is restricted to a maximum of 64×64. FIG. 13A and FIG. 13B shows examples of the two possibilities. All sub-partitions fulfil the condition of having at least 16 samples.

In ISP, the dependence of 1×N and 2×N subblock prediction on the reconstructed values of previously decoded 1×N and 2×N subblocks of the coding block is not allowed so that the minimum width of prediction for subblocks becomes four samples. For example, an 8×N (N>4) coding block that is coded using ISP with vertical split is partitioned into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks compared to processing 4×4 regular-coded intra blocks.

TABLE 3

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed consecutively. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 3. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
Transform size restriction: all ISP transforms with a length larger than 16 points uses the DCT-II.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let ty and ty be the horizontal and the vertical transforms selected respectively for the w×h sub-partition, where w is the width and h is the height. Then the transform is selected according to the following rules:
If w=1 or h=1, then there is no horizontal or vertical transform respectively.

$$\begin{matrix}If w \geq 4 and w \leq 16 , {t}_{H} = DST - VII , otherwise , {t}_{H} = DCT - II \\ If h \geq 4 and h \leq 16 , {t}_{V} = DST - VII , otherwise , {t}_{V} = DCT - II\end{matrix}$$

In ISP mode, all 67 intra modes are allowed. PDPC is also applied if corresponding width and height is at least 4 samples long. In addition, the reference sample filtering process (reference smoothing) and the condition for intra interpolation filter selection doesn't exist anymore, and Cubic (DCT-IF) filter is always applied for fractional position interpolation in ISP mode.

### Matrix Weighted Intra Prediction

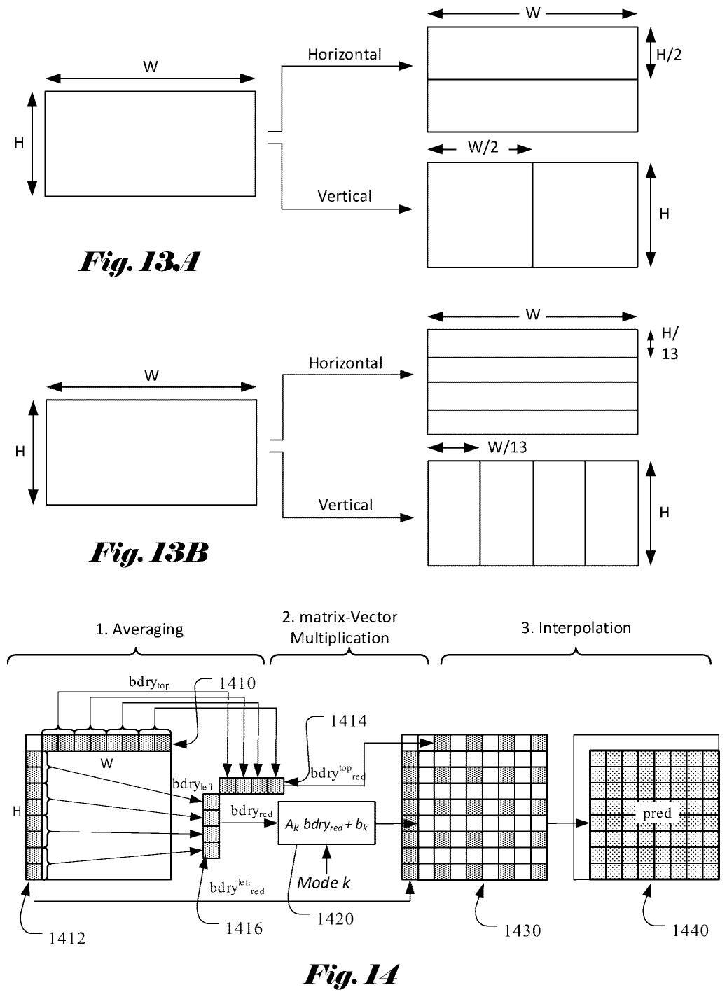

Matrix weighted intra prediction (MIP) method is a newly added intra prediction technique in VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, i.e., averaging, matrix vector multiplication and linear interpolation as shown in FIG. 14. One line of H reconstructed neighbouring boundary samples 1412 left of the block and one line of W reconstructed neighbouring boundary samples 1410 above the block are shown as dot-filled small squares. After the averaging process, the boundary samples are down-sampled to top boundary line 1414 and left boundary line 1416. The down-sampled samples are provided to the matric-vector multiplication unit 1420 to generate the down-sampled prediction block 1430. An interpolation process is then applied to generate the prediction block 1440.

### Averaging Neighbouring Samples

Among the boundary samples, four samples or eight samples are selected by averaging based on the block size and shape. Specifically, the input boundaries bdry^{top} and bdry^{left} are reduced to smaller boundaries

$$b d r {y}_{r e d}^{top} and {bdry}_{r e d}^{left}$$

by averaging neighbouring boundary samples according to a predefined rule depending on block size. Then, the two reduced boundaries

$$b d r {y}_{r e d}^{top} and {bdry}_{r e d}^{left}$$

are concatenated to a reduced boundary vector bdry_{red} which is thus of size four for blocks of shape 4×4 and of size eight for blocks of all other shapes. If mode refers to the MIP-mode, this concatenation is defined as follows:

$${bdry}_{r e d} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6.\end{matrix}$$

### Matrix Multiplication

A matrix vector multiplication, followed by addition of an offset, is carried out with the averaged samples as an input. The result is a reduced prediction signal on a subsampled set of samples in the original block. Out of the reduced input vector bdry_{red}, a reduced prediction signal pred_{red}, which is a signal on the down-sampled block of width W_{red} and height H_{red} is generated. Here, W_{red} and H_{red} are defined as:

$${W}_{r e d} = \{ \begin{matrix}4 & for max ( W , H ) \leq 8 \\ min ( W , 8 ) & for max ( W , H ) > 8\end{matrix}$$

$${H}_{r e d} = \{ \begin{matrix}4 & for max ( W , H ) \leq 8 \\ min ( H , 8 ) & for max ( W , H ) > 8\end{matrix}$$

The reduced prediction signal pred_{red} is computed by calculating a matrix vector product and adding an offset:

$$p r e {d}_{r e d} = A \cdot {bdry}_{r e d} + b .$$

Here, A is a matrix that has W_{red}·H_{red} rows and 4 columns for W=H=4 and 8 columns for all other cases. b is a vector of size W_{red}·H_{red}. The matrix A and the offset vector b are taken from one of the sets S₀, S₁, S₂. One defines an index idx=idx (W, H) as follows:

$$i d x ( W , H ) = \{ \begin{matrix}0 & for W = H = 4 ) \\ 1 & for max ( W , H ) = 8 \\ 2 & for max ( W , H ) > 8.\end{matrix}$$

Here, each coefficient of the matrix A is represented with 8-bit precision. The set S₀ consists of 16 matrices

$${A}_{0}^{i} , i ∈ \{ 0 , … , 15 \} ,$$

each of which has 16 rows and 4 columns, and 16 offset vectors b₀ⁱ, i∈{0, . . . , 16}, each of size 16. Matrices and offset vectors of that set are used for blocks of
size 4×4. The set S₁ consists of 8 matrices

$${A}_{1}^{i} , i ∈ \{ 0 , … , 7 \} ,$$

each of which has 16 rows and 8 columns, and 8 offset vectors

$${b}_{1}^{i} , i ∈ \{ 0 , … , 7 \} ,$$

each of size 16. The set S₂ consists of 6 matrices

$${A}_{2}^{i} , i ∈ \{ 0 , … , 5 \} ,$$

each of which has 64 rows and 8 columns, and 6 offset vectors

$${b}_{2}^{i} , i ∈ \{ 0 , … , 5 \} ,$$

each of size 64.

### Interpolation

The prediction signal at the remaining positions is generated from the prediction signal on the subsampled set by linear interpolation, which is a single-step linear interpolation in each direction. The interpolation is performed firstly in the horizontal direction and then in the vertical direction, regardless of block shape or block size.

Signalling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signalled. For an MIP mode, a transposed flag (isTransposed), which determines whether the mode is transposed, and MIP mode Id (modeld), which determines which matrix is to be used for the given MIP mode is derived as follows

$$isTransposed = predModeIntra \& 1$$

$$modeId = PredModeIntra >> 1$$

MIP coding mode is harmonized with other coding tools by considering following aspects:
LFNST (Low-Frequency Non-Separable Transform) is enabled for MIP on large blocks. Here, the LFNST transforms of planar mode are used
The reference sample derivation for MIP is performed exactly as for the conventional intra prediction modes
For the up-sampling step used in the MIP-prediction, original reference samples are used instead of down-sampled ones
Clipping is performed before up-sampling and not after up-sampling
MIP is allowed up to 64×64 regardless of the maximum transform size
The number of MIP modes is 32 for sizeId=0, 16 for sizeId=1 and 12 for sizeId=2

### Geometric Partitioning Mode (GPM)

In VVC, a Geometric Partitioning Mode (GPM) is supported for inter prediction as described in JVET-W2002 (Adrian Browne, et al., Algorithm description for Versatile Video Coding and Test Model 14 (VTM 14), ITU-T/ISO/IEC Joint Video Exploration Team (JVET), 23rd Meeting, by teleconference, 7-16 Jul. 2021, document: document JVET-M2002). The geometric partitioning mode is signalled using a CU-level flag as one kind of merge mode, with other merge modes including the regular merge mode, the MMVD mode, the CIIP mode and the subblock merge mode. A total of 64 partitions are supported by geometric partitioning mode for each possible CU size, w×h=2″×2″ with m, n ∈ {3 . . . 6} excluding 8×64 and 64×8. The GPM mode can be applied to skip or merge CUs having a size within the above limit and having at least two regular merge modes.

When this mode is used, a CU is split into two parts by a geometrically located straight line in certain angles. In VVC, there are a total of 20 angles and 4 offset distances used for GPM, which has been reduced from 24 angles in an earlier draft. The location of the splitting line is mathematically derived from the angle and offset parameters of a specific partition. In VVC, there are a total of 64 partitions as shown in FIG. 15, where the partitions are grouped according to their angles and dashed lines indicate redundant partitions. Each part of a geometric partition in the CU is inter-predicted using its own motion; only uni-prediction is allowed for each partition, that is, each part has one motion vector and one reference index. In FIG. 15, each line corresponds to the boundary of one partition. The partitions are grouped according to its angle. For example, partition group 1510 consists of three vertical GPM partitions (i.e., 90°). Partition group 1520 consists of four slant GPM partitions with a small angle from the vertical direction. Also, partition group 1530 consists of three vertical GPM partitions (i.e., 270°) similar to those of group 1510, but with an opposite direction. The uni-prediction motion constraint is applied to ensure that only two motion compensated prediction are needed for each CU, same as the conventional bi-prediction. The uni-prediction motion for each partition is derived using the process described later.

If geometric partitioning mode is used for the current CU, then a geometric partition index indicating the selected partition mode of the geometric partition (angle and offset), and two merge indices (one for each partition) are further signalled. The number of maximum GPM candidate size is signalled explicitly in SPS (Sequence Parameter Set) and specifies syntax binarization for GPM merge indices. After predicting each of part of the geometric partition, the sample values along the geometric partition edge are adjusted using a blending processing with adaptive weights using the process described later. This is the prediction signal for the whole CU, and transform and quantization process will be applied to the whole CU as in other prediction modes. Finally, the motion field of a CU predicted using the geometric partition modes is stored using the process described later.

### Uni-Prediction Candidate List Construction

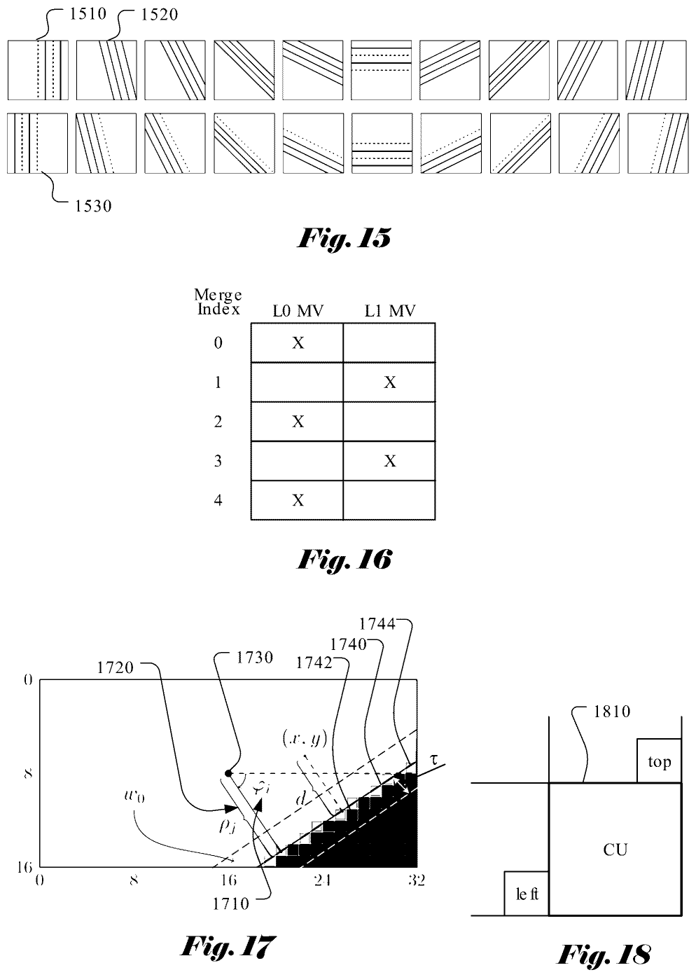

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate (X=0 or 1, i.e., LX=L0 or L1), with X equal to the parity of n, is used as the n-th uni-prediction motion vector for geometric partitioning mode. These motion vectors are marked with “x” in FIG. 16. In case a corresponding LX motion vector of the n—the extended merge candidate does not exist, the L(1-X) motion vector of the same candidate is used instead as the uni-prediction motion vector for geometric partitioning mode.

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 3 )$$

$${ρ}_{j} = {ρ}_{x , j} cos ( {φ}_{i} ) + {ρ}_{y , j} sin ( {φ}_{i} ) \qquad ( 4 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 5 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 6 )$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 7 )$$

$${w}_{0} ( x , y ) = \frac{C lip 3 ( 0 , 8 , ( wIdxL ( x , y ) + 4 ) ≫ 3 )}{8} \qquad ( 8 )$$

$${w}_{1} ( x , y ) = 1 - {w}_{0} ( x , y ) \qquad ( 9 )$$

The partIdx depends on the angle index i. One example of weigh w₀ is illustrated in FIG. 17, where the angle φᵢ 1710 and offset ρi 1720 are indicated for GPM index i and point 1730 corresponds to the centre of the block. Line 1740 corresponds to the GPM partitioning boundary. Motion Field Storage for Geometric Partitioning Mode

Mv1 from the first part of the geometric partition, Mv2 from the second part of the geometric partition and a combined MV of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 10 )$$

where motionIdx is equal to d(4x+2, 4y+2), which is recalculated from equation (3). The partIdx depends on the angle index i.

If sType is equal to 0 or 1, Mv0 or Mv1 are stored in the corresponding motion field, otherwise if sType is equal to 2, a combined MV from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

### Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pinter is derived using the same inter prediction process applied to regular merge mode; and the intra prediction signal Pintra is derived following the regular intra prediction process with the planar mode. Then, the intra and inter prediction signals are combined using weighted averaging, where the weight value wt is calculated depending on the coding modes of the top and left neighbouring blocks (as shown in FIG. 18) of current CU 1810 as follows:
If the top neighbour is available and intra coded, then set isIntraTop to 1, otherwise set isIntraTop to 0;
If the left neighbour is available and intra coded, then set isIntraLeft to 1, otherwise set isIntraLeft to 0;
If (isIntraLeft+isIntra Top) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{inter} + wt * {P}_{intra} + 2 ) ≫ 2 \qquad ( 11 )$$

### GPM Extension

Several variations of GPM mode (JVET-W0097 (Zhipin Deng, et. al., “AEE2-related: Combination of EE2-3.3, EE2-3.4 and EE2-3.5”, Joint Video Experts Team (JVET) of ITU-T SG 16 WP 3 and ISO/IEC JTC 1/SC 29, 23rd Meeting, by teleconference, 7-16 Jul. 2021, Document: JVET-W0097) and JVET-Y0065 (Yoshitaka Kidani, et. al., “EE2-3.1: GPM with inter and intra prediction (JVET-X0166)”, Joint Video Experts Team (JVET) of ITU-T SG 16 WP 3 and ISO/IEC JTC 1/SC 29, 25th Meeting, by teleconference, 12-21 Jan. 2022, Document: JVET-Y0065) have been proposed to improve the coding efficiency of the GPM mode in the VVC. The methods were included in the exploration experiment (EE2) for further evaluations, the main technical aspects of which are described as follows:

EE2-3.3 on GPM with MMVD (GPM-MMVD): 1) additional MVDs are added to the existing GPM merge candidates; 2) the MVDs are signalled in the same manner as the MMVD in the VVC, i.e., one distance index plus one direction index; 3) two flags are signalled to separately control whether the MMVD is applied to each GPM partition or not.

EE2-3.4-3.5 on GPM with template matching (GPM-TM): 1) template matching is extended to the GPM mode by refining the GPM MVs based on the left and above neighbouring samples of the current CU; 2) the template samples are selected dependent on the GPM split direction; 3) one single flag is signalled to jointly control whether the template matching is applied to the MVs of two GPM partitions or not.

JVET-W0097 proposes a combination of EE2-3.3, EE2-3.4 and EE2-3.5 to further improve the coding efficiency of the GPM mode. Specifically, in the proposed combination, the existing designs in EE2-3.3, EE2-3.4 and EE2-3.5 are kept unchanged while the following modifications are further applied for the harmonization of the two coding tools:
1) The GPM-MMVD and GPM-TM are exclusively enabled to one GPM CU. This is done by firstly signalling the GPM-MMVD syntax. When both two GPM-MMVD control flags are equal to false (i.e., the GPM-MMVD are disabled for two GPM partitions), the GPM-TM flag is signalled to indicate whether the template matching is applied to the two GPM partitions. Otherwise (at least one GPM-MMVD flag is equal to true), the value of the GPM-TM flag is inferred to be false.
2) The GPM merge candidate list generation methods in EE2-3.3 and EE2-3.4-3.5 are directly combined in a manner that the MV pruning scheme in EE2-3.4-3.5 (where the MV pruning threshold is adapted based on the current CU size) is applied to replace the default MV pruning scheme applied in EE2-3.3; additionally, as in EE2-3.4-3.5, multiple zero MVs are added until the GPM candidate list is fully filled.

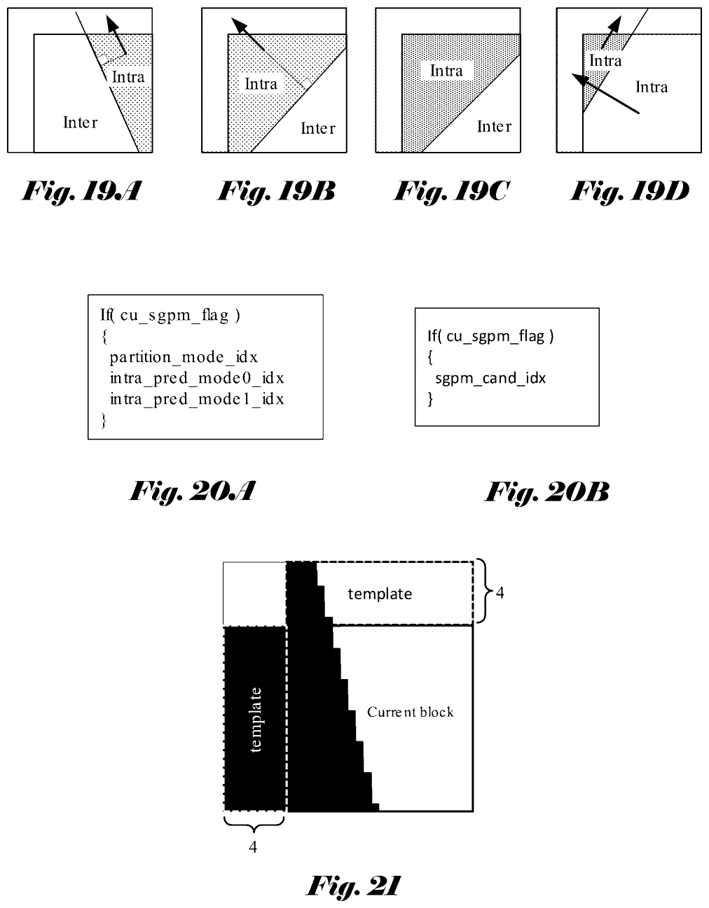

In JVET-Y0065, in GPM with inter and intra prediction (or named GPM intra), the final prediction samples are generated by weighting inter predicted samples and intra predicted samples for each GPM-separated region. The inter predicted samples are derived by the same scheme as the GPM in the current ECM whereas the intra predicted samples are derived by an intra prediction mode (IPM) candidate list and an index signalled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown FIGS. 19A-C, respectively. Furthermore, GPM with intra and intra prediction as shown FIG. 19D is restricted in the proposed method to reduce the signalling overhead for IPMs and avoid an increase in the size of the intra prediction circuit on the hardware decoder. In addition, a direct motion vector and IPM storage on the GPM-blending area is introduced to further improve the coding performance.

### Spatial GPM

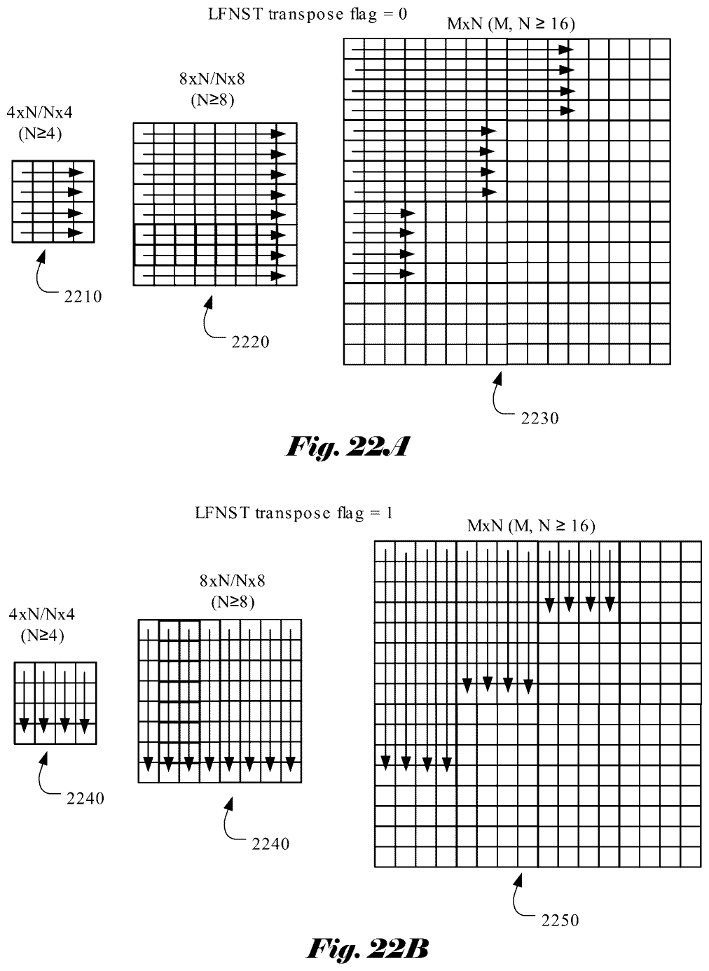

Similar to inter GPM, Spatial GPM (SGPM) consists of one partition mode and two associated intra prediction modes. If these modes are directly signalled in the bit-stream, as shown in FIG. 20A, it would yield significant overhead bits. To express the necessary partition and prediction information more efficiently in the bit-stream, a candidate list is employed and only the candidate index is signalled in the bit-stream. Each candidate in the list can derive a combination of one partition mode and two intra prediction modes, as shown in FIG. 20B.

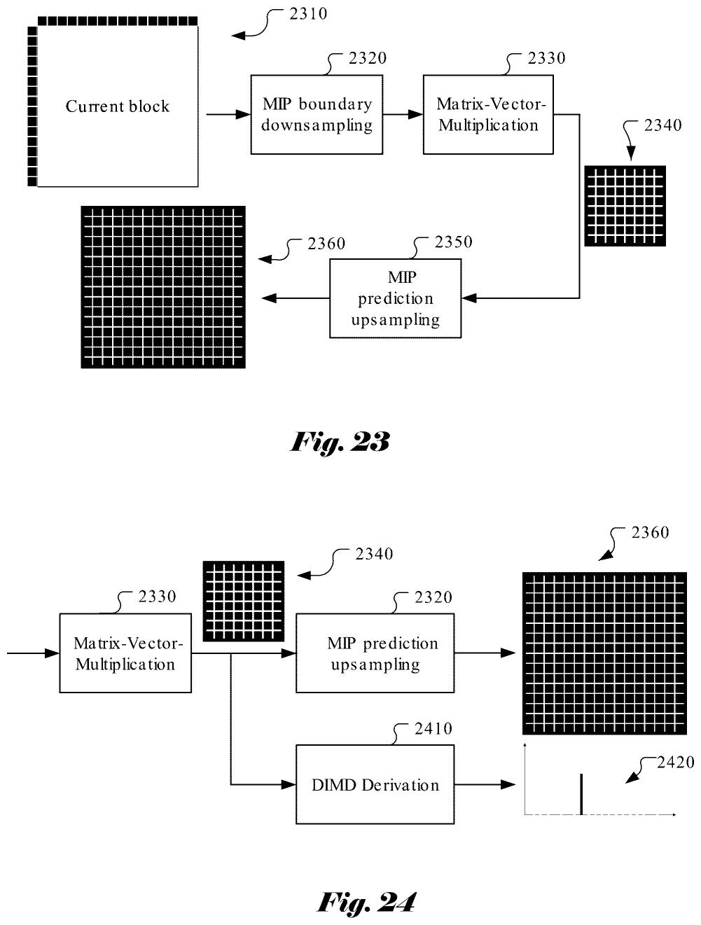

A template is used to generate this candidate list. The shape of the template is shown in FIG. 21. For each possible combination of one partition mode and two intra prediction modes, a prediction is generated for the template with the partitioning weight extended to the template, as shown in FIG. 21. These combinations are ranked in ascending order of their SATD between the prediction and reconstruction of the template. The length of the candidate list is set equal to 16, and these candidates are regarded as the most probable SGPM combinations of the current block. Both encoder and decoder construct the same candidate list based upon the template.

To reduce the complexity in building the candidate list, both the number of possible partition modes and the number of possible intra prediction modes are pruned. In the following test, 26 out of 64 partition modes are used, and only the MPMs out of 67 intra prediction modes are used.

In JVET-AA0118 (Fan Wang, et. al., “EE2-1.4: Spatial GPM”, Joint Video Experts Team (JVET) of ITU-T SG 16 WP 3 and ISO/IEC JTC 1/SC 29, 27th Meeting, by teleconference, 13-22 Jul. 2022, Document: JVET-AA0118), some schemes to speed up the encoding process of SGPM and improve the gain of SGPM are disclosed and some key techniques related to MIP are reviewed as follows.

### EE2-4.1: Modification of LFNST for MIP Coded Block

In ECM6.0 (Muhammed Coban, et. al., “Algorithm description of Enhanced Compression Model 6 (ECM 6)”, Joint Video Experts Team (JVET) of ITU-T SG 16 WP 3 and ISO/IEC JTC 1/SC 29, 27th Meeting, by teleconference, 13-22 Jul. 2022, Document: JVET-AA202), the LFNST transform set and LFNST transpose flag are both determined by the intra prediction mode predModeIntra of the current transform block. With the predModeIntra, the following operation is conducted:
If the current block is MIP coded block, predModeIntra is mapped to PLANAR;
If the current block is CCLM coded block, predModeIntra is mapped to the co-located luma intra prediction mode;

Then, predModeIntra is further derived from wide angle intra prediction mapping with a range of [−14, 83].

### Selection of LFNST Transform Sets

There are totally 35 transform sets and 3 non-separable transform matrices (kernels) per transform set in LFNST in ECM6.0. The transform set idx IfnstTrSetIdx is defined according to predModeIntra list in Table 4.

TABLE 4
LFNST transform set selection

| | Intra pred. mode | | | | | | | | | | | | | | | |
|---|---|---|---|---|---|---|---|---|---|---|---|---|---|---|---|---|
| | −14 | −13 | −12 | −11 | −10 | −9 | −8 | −7 | −6 | −5 | −4 | −3 | −2 | −1 | 0 | 1 |
| LFNST set index | 2 | 2 | 2 | 2 | 2 | 2 | 2 | 2 | 2 | 2 | 2 | 2 | 2 | 2 | 0 | 1 |

| | Intra pred. mode | | | | | | | | | | | | | | | |
|---|---|---|---|---|---|---|---|---|---|---|---|---|---|---|---|---|
| | 2 | 3 | 4 | 5 | 6 | 7 | 8 | 9 | 10 | 11 | 12 | 13 | 14 | 15 | 16 | 17 |
| LFNST set index | 2 | 3 | 4 | 5 | 6 | 7 | 8 | 9 | 10 | 11 | 12 | 13 | 14 | 15 | 16 | 17 |
| | Intra pred. mode | | | | | | | | | | | | | | | |
| | 18 | 19 | 20 | 21 | 22 | 23 | 24 | 25 | 26 | 27 | 28 | 29 | 30 | 31 | 32 | 33 |
| LFNST set index | 18 | 19 | 20 | 21 | 22 | 23 | 24 | 25 | 26 | 27 | 28 | 29 | 30 | 31 | 32 | 33 |
| | Intra pred. mode | | | | | | | | | | | | | | | |
| | 34 | 35 | 36 | 37 | 38 | 39 | 40 | 41 | 42 | 43 | 44 | 45 | 46 | 47 | 48 | 49 |
| LFNST set index | 34 | 33 | 32 | 31 | 30 | 29 | 28 | 27 | 26 | 25 | 24 | 23 | 22 | 21 | 20 | 19 |
| | Intra pred. mode | | | | | | | | | | | | | | | |
| | 50 | 51 | 52 | 53 | 54 | 55 | 56 | 57 | 58 | 59 | 60 | 61 | 62 | 63 | 64 | 65 |
| LFNST set index | 18 | 17 | 16 | 15 | 14 | 13 | 12 | 11 | 10 | 9 | 8 | 7 | 6 | 5 | 4 | 3 |

| | Intra pred. mode | | | | | | | | | | | | | | |
|---|---|---|---|---|---|---|---|---|---|---|---|---|---|---|---|
| | 66 | 67 | 68 | 69 | 70 | 71 | 72 | 73 | 74 | 75 | 76 | 77 | 78 | 79 | 80 |
| LFNST set index | 2 | 2 | 2 | 2 | 2 | 2 | 2 | 2 | 2 | 2 | 2 | 2 | 2 | 2 | 2 |

### Determination of LFNST Transpose Flag

The LFNST transpose flag determines the scan order of the LFNST output (Decoder). FIG. 22 shows the scan order with different LFNST transpose flag (FIG. 22A for flag equal to 0 and FIG. 22B for flag equal to 1).

The LFNST transpose flag is determined by predModeIntra as follows:
if predModeIntra is less than or equal to 34, the LFNST transpose flag is set to 0;
else, the LFNST transpose flag is set to 1.

For MIP coded blocks, it is mapped to the PLANAR mode, the LFNST transform set 0 is used and LFNST transpose flag is always equal to 0.

In ECM6.0, LFNST is enable for the MIP coded blocks with the width and height greater than or equal to 16.

### Prediction Process of MIP

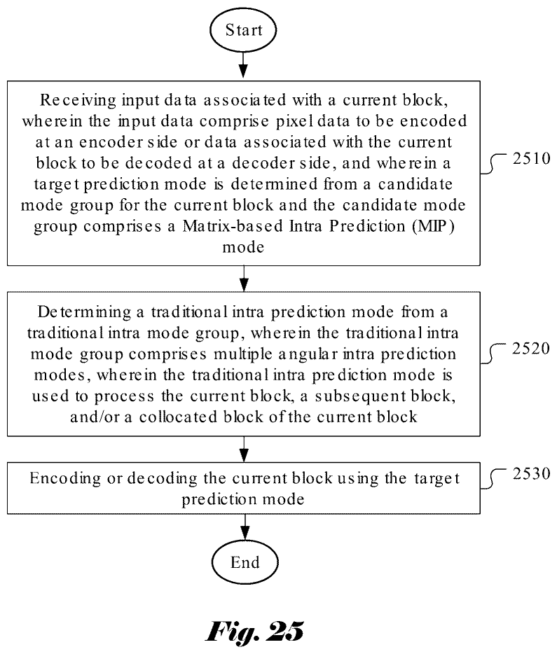

As mentioned earlier, Matrix weighted intra prediction (MIP) takes one line of H reconstructed neighbouring boundary samples on the left of the block and one line of W reconstructed neighbouring boundary samples above the block as input. The generation of the prediction samples is based on the following three steps: the input 2310 comprising boundary samples (shown as darker squares) around a current block is provided to boundary downsampling module 2320; and then processed by matrix vector multiplication module 2330 to generate MIP prediction 2340; and further processed by MIP prediction upsampling module 2350 to generate the upsampled output 2360 as shown in FIG. 23.

Specifically, MIP first downsamples the reference samples, and then multiplies the downsampled reference samples with the prediction matrix to generate partial prediction samples. Finally, it is upsampled to generate predicted samples at the remaining positions.

### Modification of LFNST for MIP Coded Blocks

In JVET-AB0067 (Junyan Huo, et. al., “EE2-4.1: Modification of LFNST for MIP coded block”, Joint Video Experts Team (JVET) of ITU-T SG 16 WP 3 and ISO/IEC JTC 1/SC 29, 28th Meeting, Mainz, DE, 21-28 Oct. 2022, Document: JVET-AB0067), it is proposed to utilize DIMD to derive the LFNST transform set and determine LFNST transpose flag.

The proposed method uses the DIMD 2410 to derive the intra prediction mode of the current block based on the MIP predicted samples before upsampling. Specifically, a horizontal gradient and a vertical gradient are calculated for each predicted sample to build a HoG 2420, as shown in FIG. 24. Then the intra prediction mode with the largest histogram amplitude values is used to determine the LFNST transform set and LFNST Transpose flag.

Furthermore, LFNST is enabled for MIP coded blocks of width and height greater than or equal to 4.

### Enhanced MTS for Intra Coding

In the current VVC design, for MTS (Multi Transform Selection), only DST7 and DCT8 transform kernels are utilized, which are used for intra and inter coding.

Additional primary transforms including DCT5, DST4, DST1, and identity transform (IDT) are employed. Also MTS set is made dependent on the TU size and intra mode information. 16 different TU sizes are considered, and for each TU size, 5 different classes are considered depending on intra-mode information. For each class, 1, 4 or 6 different transform pairs are considered. Number of intra MTS candidates are adaptively selected (between 1, 4 and 6 MTS candidates) depending on the sum of absolute value of transform coefficients. The sum is compared against the two fixed thresholds to determine the total number of allowed MTS candidates:

$$\begin{matrix}1 candidate : sum <= th 0 , \\ 4 candidates : th 0 < sum <= th 1 , \\ 6 candidates : sum > th 1.\end{matrix}$$

Note, although a total of 80 different classes are considered, some of those different classes often share exactly the same transform set. So there are 58 (less than 80) unique entries in the resultant LUT.

For angular modes, a joint symmetry over TU shape and intra prediction is considered. So, a mode i (i>34) with TU shape A×B will be mapped to the same class corresponding to the mode j=(68-i) with TU shape B×A. However, for each transform pair the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between −2 and −14. Similarly, mode 66 is used for mode 67 to mode 80.

### Chroma DM Mode

For Chroma DM mode, the intra prediction mode of the corresponding (collocated) luma block covering the centre position of the current chroma block is directly inherited.

In this invention, a novel mechanism of handling the intra prediction mode for a target prediction mode (for example, a special intra mode or any other special prediction mode) is proposed. The target prediction mode means that when the current block is coded with the target prediction mode (for example, the special intra mode means that when the current block is coded with the special intra mode), instead of using a traditional intra prediction mode (e.g. one of 67 intra prediction modes, including DC, planar, and 65 angular prediction modes) to generate the predictors for the current block, an alternative scheme is applied to the spatially neighbouring reference samples to generate the predictors for the current block. For example, the target prediction mode (for example, the special intra mode) may refer to Matrix-based Intra Prediction (MIP). However, it is understood that the MIP is just an example of target prediction mode (for example, the special intra mode) and other target prediction modes or special intra modes may also be used to practice the present invention. In this disclosure, a collection of target prediction modes (for example, the special intra modes) is referred as a candidate prediction mode group (for example, a special intra mode group). When a target prediction mode (for example, a special intra mode) is used for a block, however, in some cases, the intra prediction mode for the current block may still be required. For example:
On the following encoding/decoding stages after prediction process, it will use the intra prediction mode for the current block.
   At the encoder, for a non-transform-skip block, the residuals are transformed according to the transform kernel of the primary transform to get the first transformed coefficients, and if the secondary transform is applied, the first transformed coefficients are further transformed according to the transform kernel of the secondary transform. At the decoder, for a non-transform-skip block, if the secondary transform is applied, the transformed coefficients are inverse-transformed according to the transform kernel of the secondary transform to get the first transformed coefficients which will be further inverse-transformed according to the transform kernel of the primary transform.
   On the transform/inverse transform stage, the intra prediction mode is used by secondary transform. The transform kernel selection for the secondary transform depends on the intra prediction mode. An example is selecting the transform kernel and/or the transform set and/or the transpose flag for secondary transform (e.g. LFNST). The proposed method is not limited to be used for a specific type of the secondary transform and/or can be used for any type of secondary transform. For example, the secondary transform can be separable and/or non-separable secondary transform.
   On the transform/inverse transform stage, the intra prediction mode is used by primary transform. The transform kernel selection for the primary transform depends on the intra prediction mode. An example is selecting the transform kernel and/or the transform set and/or the transpose flag for the primary transform (e.g. MTS). The proposed method is not limited to be used for a specific type of the primary transform and/or can be used for any type of primary transform. For example, the primary transform can be separable and/or non-separable primary transform.
For the subsequent coding blocks, the intra prediction mode information from one or more neighbouring coded blocks is used for deriving the MPM list. For example, the MPM list includes multiple candidates with inherited information (i.e. intra prediction mode) and when deriving the list, the inherited information can be from any pre-defined reference blocks which were coded before or any pre-stored mode information. If one of the predefined reference blocks refers to the spatial adjacent neighbouring block (of the current block) which was coded using the special prediction mode, since the proposed method could determine the intra prediction mode for the special prediction mode, the intra prediction mode for this reference block can be inherited during the list construction. If one of the predefined reference blocks refers to the spatial non-adjacent neighbouring block (of the current block) which was coded using the special prediction mode, since the proposed method could determine the intra prediction mode for the special prediction mode, the intra prediction mode for this reference block can be inherited during the list construction. If one of the pre-stored mode information is from a history-based candidate (selected from a history-based table, which stores the mode information from the previous coded blocks and/or resets empty at the beginning or the ending of each CTU/CTU row/slice/picture/tile or any predefined timing and/or includes the new-added mode information at the ending of the history-based table and/or excluding the early-added mode information at the front of the history-based table when the history-based table is full) which stored from a coded block using the special prediction mode, since the proposed method could determine the intra prediction mode for the special prediction mode, the intra prediction mode for this stored mode information can be inherited during the list construction.
If the current block is a luma block, the collocated chroma block may need the intra prediction mode from luma (e.g. to decide the chroma DM).

Therefore, when a target prediction mode (for example, the special intra mode) is applied to the current block, the proposed novel mechanism can be used to pre-define an intra prediction mode for using in the one or more above-motioned cases.

In one embodiment, the pre-defined intra prediction mode is any one of DIMD derived mode, TIMD derived mode, DC, planar, horizontal, vertical, diagonal, or any pre-defined mode from the available intra prediction modes. The derivation method can depend on histogram/gradient/distortion analysis on template of the current block and/or histogram/gradient/distortion analysis on the current block. For an example of using histogram and gradient as performing DIMD on template of the current block, the horizontal and vertical filters are applied to all or any pre-defined neighbouring template region of the current block and the histogram for each intra prediction mode is calculated according to the gradient results after filtering. The DIMD-derived mode will be determined by the histograms and in one way, the DIMD derived mode will be the intra prediction mode with the largest histogram. For another example of using histogram and gradient as performing DIMD on the current block, the horizontal and vertical filters are applied to all or any pre-defined predicted samples in the current block and the histogram for each intra prediction mode is calculated according to the gradient results after filtering. In one sub-embodiment, the pre-defined predicted samples may be the final predictors for the current block. In another sub-embodiment, the pre-defined predicted samples may be the intermediate predictors for the current block. The DIMD-derived mode will be determined by the histograms and in one way, the DIMD derived mode will be the intra prediction mode with the largest histogram. For another example of using distortion as performing TIMD on template of the current block, the cost for each candidate intra prediction mode is calculated by the distortion between the reconstruction on a pre-defined neighbouring template region of the current block and the prediction (from a candidate intra prediction mode) on a pre-defined neighbouring template region of the current block. The TIMD-derived mode will be determined by the distortions and in one way, the TIMD derived mode will be the intra prediction mode with the smallest distortion. For another example of using distortion as performing TIMD on the current block, the cost for each candidate intra prediction mode is calculated by the distortion between the real prediction (i.e. MIP prediction if the current block is coded by MIP.) on a pre-defined region in the current block and the prediction (from a candidate intra prediction mode) on a pre-defined region in the current block. The TIMD-derived mode will be determined by the distortions and in one way, the TIMD derived mode will be the intra prediction mode with the smallest distortion. When determining the pre-defined intra prediction mode for the current block using the special intra prediction mode, different proposed methods can be combined. For example, the histogram and distortion can be jointly considered. For another example, in case of the block width/height/area larger than or smaller than a threshold, TIMD/DIMD derived modes are used to determine the pre-defined intra prediction mode for the current block; in otherwise case, a default mode is set as the pre-defined intra prediction mode for the current block. Take the current block coded by MIP and the pre-defined intra prediction mode being DIMD derived mode as an example. The DIMD derived mode is stored for MIP and can be used for:
the subsequent blocks to derive the MPM list
the collocated chroma block (in the case of the current block being luma) to decide its intra prediction mode (e.g. to derive chroma DM)
the current block to decide the transform kernel for the any transform process, such as primary transform and secondary transform

In another embodiment, the proposed methods can be used for colour format 4:4:4. The following shows an example. MIP can be used for chroma when the colour format is 4:4:4. For a chroma MIP block, the pre-defined intra prediction mode can be used for secondary transform to select the transform set and transpose flag.

In another embodiment, the pre-defined mode is stored in the buffer for the intra prediction mode when the current block is coded with a special intra mode. If any following process needs to access the buffer for intra prediction mode, the buffer for intra prediction mode is set well (i.e., can be obtained from the buffer).

In another embodiment, the pre-defined mode can implicitly vary with the block width, block height, block area or vary according to an explicit rule (e.g. syntax on block, tile, slice, picture, SPS, or PPS level).

In another embodiment, any proposed methods or any combinations of the propose methods can be applied to any target prediction mode which does not use a traditional intra prediction mode to generate the prediction of the current block. Example of some target prediction modes, to which the proposed methods can be applied, may include intra modes such as WAIP, intra angular modes, ISP, MIP, or any intra mode specified in the VVC or HEVC. For more examples of the special prediction modes, GPM variations, SGPM, all or any pre-defined sub-modes of intra/inter types, and/or intra block copy which uses block vectors to indicate a reference block in the same picture of the current block and uses the reconstructed samples of the reference block to predict the current block where the block vectors can be determined by explicitly signalling and/or implicit derivation such as searching a pre-defined coded region and finding the reference block with a smaller distortion between the neighbouring template of the reference block and the neighbouring template of the current block.

The proposed target prediction mode (i.e. MIP) with pre-defined traditional intra mode derivation methods in this invention can be enabled and/or disabled according to implicit rules (e.g. block width, height, or area) or according to explicit rules (e.g. syntax on block, tile, slice, picture, SPS, or PPS level). For example, the proposed method is applied when the block area is smaller/larger than a threshold. For example, the proposed method is applied when the block width and/or block height is smaller than a threshold. For another example, the proposed method is applied when the block width and/or block height is larger than a threshold.

The term “block” in this invention can refer to TU/TB, CU/CB, PU/PB, pre-defined region, or CTU/CTB.

Any combination of the proposed methods in this invention can be applied.

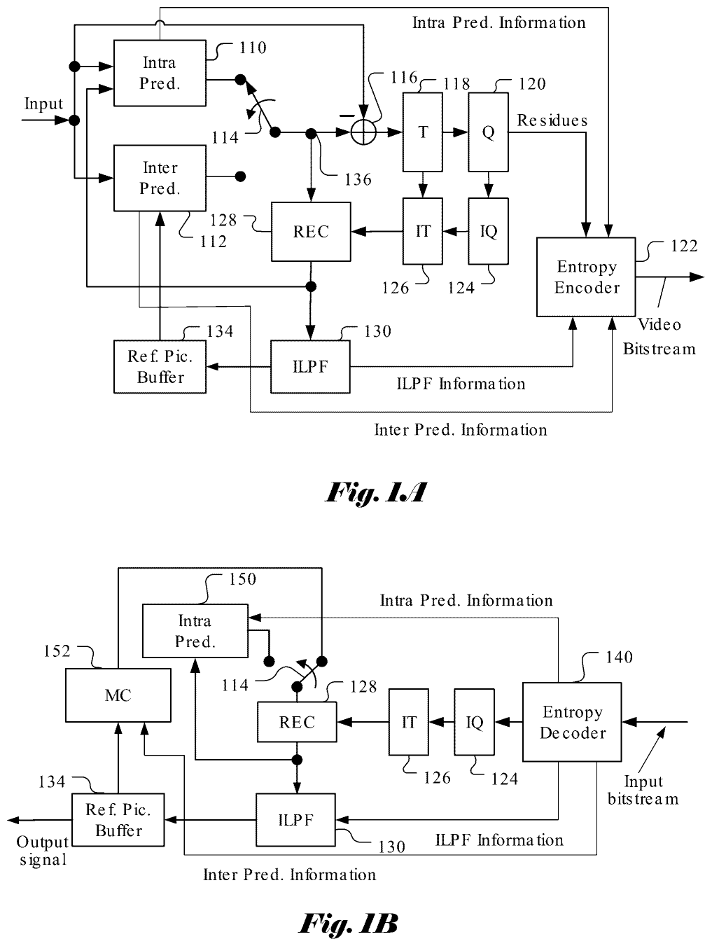

The target prediction mode (i.e. MIP) with pre-defined traditional intra mode derivation methods as described above can be implemented in an encoder side or a decoder side. For example, any of the proposed methods can be implemented in an Intra prediction module (e.g. Intra Pred. 150 in FIG. 1B) in a decoder or an Intra prediction module in an encoder (e.g. Intra Pred. 110 in FIG. 1A). Any of the proposed methods can also be implemented as a circuit coupled to the intra coding module at the decoder or the encoder. However, the decoder or encoder may also use additional processing unit to implement the required processing. While the Intra prediction units (e.g. unit 110 in FIG. 1A and unit 150 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 25 illustrates a flowchart of an exemplary video coding system that incorporates matrix weighted intra prediction mode according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block are received in step 2510, wherein the input data comprise pixel data to be encoded at an encoder side or data associated with the current block to be decoded at a decoder side, and wherein a target prediction mode is determined from a candidate mode group for the current block and the candidate mode group comprises a Matrix-based Intra Prediction (MIP) mode. A traditional intra prediction mode is determined from a traditional intra mode group in step 2520, wherein the traditional intra mode group comprises multiple angular intra prediction modes, wherein the traditional intra prediction mode is used to process the current block, a subsequent block, and/or a collocated block of the current block. The current block is encoded or decoded using the target prediction mode in step 2530.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data to be encoded at an encoder side or data associated with the current block to be decoded at a decoder side, and wherein a target prediction mode is determined from a candidate mode group for the current block and the candidate mode group comprises a Matrix-based Intra Prediction (MIP) mode;
determining a traditional intra prediction mode from a traditional intra mode group, wherein the traditional intra mode group comprises multiple angular intra prediction modes, wherein the traditional intra prediction mode is used to process the current block, a subsequent block, and/or a collocated block of the current block; and
encoding or decoding the current block using the target prediction mode.

2. The method of claim 1, wherein the traditional intra prediction mode is used for the current block during transform or inverse transform stage.

3. The method of claim 2, wherein the traditional intra prediction mode is used for the current block to select a transform set and/or a transpose flag and/or a transform kernel for secondary transform.

4. The method of claim 2, wherein the traditional intra prediction mode is used for the current block to select a transform set and/or transform kernel and/or a transpose flag for primary transform.

5. The method of claim 1, wherein the traditional intra prediction mode is used by a subsequent coding block to construct a Most Probably Mode (MPM) list.

6. The method of claim 1, wherein the current block corresponds to a luma block and the traditional intra prediction mode is used by a collocated chroma block to decide a chroma derived mode (DM).

7. The method of claim 1, wherein the traditional intra prediction mode corresponds to a pre-defined intra prediction mode.

8. The method of claim 7, wherein the pre-defined intra prediction mode is derived according to histogram/gradient/distortion analysis on template of the current block and/or histogram/gradient/distortion analysis on the current block.

9. The method of claim 7, wherein the pre-defined intra prediction mode corresponds to DC, planar, horizontal, vertical, diagonal, or any pre-defined mode from available intra prediction modes.

10. The method of claim 7, wherein the pre-defined intra prediction mode is selected to be the DC, planar, horizontal, vertical, diagonal, or any pre-defined mode from available intra prediction modes according to one or more implicit rules.

11. The method of claim 7, wherein the pre-defined intra prediction mode is determined according to block size of the current block.

12. The method of claim 7, wherein the pre-defined intra prediction mode is determined according a syntax in a block, tile, slice, picture, SPS (Sequence Parameter Set), or PPS (Picture Parameter Set) level.

13. The method of claim 1, wherein the traditional intra prediction mode is stored in a buffer for intra prediction modes.

14. The method of claim 13, wherein the traditional intra prediction mode stored in the buffer is accessed by the current block, the subsequent block, and/or the collocated block.

15. An apparatus of video coding, the apparatus comprising one or more electronics or processors arranged to:
receive input data associated with a current block, wherein the input data comprise pixel data to be encoded at an encoder side or data associated with the current block to be decoded at a decoder side, and wherein a target prediction mode is determined from a candidate mode group for the current block and the candidate mode group comprises a Matrix-based Intra Prediction (MIP) mode;
determine a traditional intra prediction mode from a traditional intra mode group, wherein the traditional intra mode group comprises multiple angular intra prediction modes, wherein the traditional intra prediction mode is used to process the current block, a subsequent block, and/or a collocated block of the current block; and
encode or decode the current block using the target prediction mode.
